(19) United States
(12) Patent Application Publication
(10) Pub. No.: US 2020/0047448 A1
(43) Pub. Date: Feb. 13, 2020

(54) CONTAINER WITH SKIM COAT LAYER FOR IMPROVED PUNCTUREABILITY

(71) Applicant: Printpack Illinois, Inc., Elgin, IL (US)

(72) Inventors: David T. Foster, Williamsburg, VA (US); John Craig Small, Mathews, VA (US); Paul Lamont, Williamsburg, VA (US); Richard Sutton Pepersack, Williamsburg, VA (US); Harold Stephen Bowen, Hayes, VA (US)

(73) Assignee: Printpack Illinois, Inc., Elgin, IL (US)

(21) Appl. No.: 16/342,738

(22) PCT Filed: Oct. 16, 2017
(86) PCT No.: PCT/US2017/056752

§ 371 Date: Apr. 17, 2019

Related U.S. Application Data
(60) Provisional application No. 62/408,917, filed on Oct. 17, 2016.

(51) Int. Cl. B32B 1/02; B65D 85/804; B32B 27/32; B32B 27/08; B32B 7/02; B32B 27/30; B32B 7/12; B32B 27/18; B29D 22/00

(52) U.S. Cl. CPC B32B 1/02; B65D 85/8043; B32B 27/32; B32B 27/08; B32B 7/02; B32B 27/306; B29K 2023/12; B32B 27/18; B29D 22/003; B32B 2439/70; B32B 2250/246; B32B 2270/00; B32B 2264/102; B32B 7/12

(57) ABSTRACT

Containers having a skim coat layer for improved punctureability, and sheet stock materials for and methods of making such containers are provided. A container is formed of a first material layer that contains a monolayer of polypropylene homopolymer in an amount of at least 70 percent by weight, or a multilayer material in which at least one layer comprises a polypropylene homopolymer in an amount of at least 70 percent by, and a second material layer adjacent the first material layer and forming an innermost layer adjacent the cavity, the second material layer containing a polypropylene copolymer in an amount of at least 60 percent by weight.

### CROSS-REFERENCE TO RELATED APPLICATIONS

This application claims priority benefit of U.S. Provisional Application No. 62/408,917, filed Oct. 17, 2016, which is incorporated herein by reference.

### BACKGROUND

The present application relates generally to the field of containers for preparation of beverages, especially coffee and tea. These containers commonly are referred to as cartridges, cups, capsules, or pods, and are particularly suitable for use in the preparation of a single-serve beverage.

In recent years, single-serve beverage machines have become popular in homes and businesses as a quick and convenient manner of brewing beverages. These machines generally brew coffee, tea, or other hot beverages through polymer containers that may have integral filters and are filled with coffee grinds, tea leaves, or other soluble products. Upon brewing of these products, the container may be easily discarded so that the machine is available for preparation of subsequent beverages. These containers thereby enable users to customize their beverages and also enjoy freshly brewed beverages quickly and easily.

Although convenient, existing containers used for the preparation of beverages have numerous drawbacks. For example, many commercially available containers are prepared using materials that are less easily recycled. This is due at least in part due to the structural characteristics that are required for these containers. For example, the containers must be sufficiently strong to permit puncturing of the base of the container without substantial deformation of the container. Attempts to manufacture containers from material structures that are more easily recycled have resulted in issues including poor punctureability of the containers, such as cracking and the formation of chads during puncture.

Thus, there is a need for containers that are more easily recycled while providing the desired punctureability characteristics, as well as reducing cracking and the formation of chads.

### BRIEF DESCRIPTION OF THE DRAWINGS

FIG. 1 is a side view of an embodiment of a container according to a first embodiment.

FIG. 2 is a bottom view the container illustrated in FIG. 1.

FIG. 3 is a top view of the container illustrated in FIG. 1.

FIG. 4 is a forward lower perspective view of the container illustrated in FIG. 1.

FIG. 5 is a cross-sectional side view of an embodiment of the container illustrated in FIG. 1.

FIG. 6 is a forward lower perspective view of a container according to a second embodiment.

FIG. 7 is a cross-sectional view of the embodiment of the container illustrated in FIG. 6.

FIG. 8 is a bottom view the container illustrated in FIG. 6.

FIG. 9 is a schematic illustration of a design that may be applied to the inner surface of a container base according to an embodiment.

FIG. 10 is a schematic illustration of a design that may be applied to the inner surface of a container base according to an embodiment.

FIG. 11 is a graph showing the comparative results of the broken chad test of the Example.

FIG. 12 is a graph showing the comparative results of the hanging chad test of the Example.

FIG. 13 is a graph showing the comparative results of the cracked cups test of the Example.

FIG. 14 is a graph showing the comparative results of the no punches test of the Example.

FIG. 15 is a graph showing the comparative results of the hanging chad test of the Example.

FIG. 16 is a graph showing the comparative results of the cracked cups test of the Example.

FIG. 17 is a graph showing the comparative results of the no punches test of the Example.

### DETAILED DESCRIPTION

Containers and sheet stock materials and methods for making such containers have been developed to provide containers that are more easily recycled and that display improved puncture characteristics while providing the desired punctureability characteristics, such as reducing cracking and the formation of chads.

The containers embodied herein are particularly suited for use in an automatic machine, such as a single-serve coffee brewing machine. Upon placing the container in the machine, a piercing member punctures the cover to introduce pressurized hot water through the hole where it comes into contact with the beverage ingredients disposed in the filter. A second piercing member punctures the base of the container at any position in the base to enable the prepared beverage to flow out of the container and be dispensed into a cup or container for consumption by the consumer.

The containers provided herein also may be configured for use with other types of food products, non-limiting examples of which include dry ingredients for preparing broths, soups, and sauces that may be eaten be themselves or used to prepare a food dish.

Containers and Sheet Stock Materials Therefor

Embodiments of the present application address the above-described needs by providing a container for preparation of a beverage and sheet stock materials for the manufacture thereof. As used herein, the term “container” is synonymous with cartridges, cups, capsules, pods, and the like, that may be used in the preparation of a beverage.

The container generally includes a cup-shaped container with a substantially circular base and a frustoconically shaped sidewall defining an opening. As will be described in more detail below, the cup-shaped containers may include a variety of base designs or configurations that serve to enhance the rigidity and resulting punctureability of the base of the container. For example, these containers may have container designs as described and/or illustrated in U.S. Patent Application Publications No. 2014/0120217, 2014/0120218, and 2014/0308406, PCT Application Publication No. WO 2015/191565, U.S. Design patent Nos. D686,916, D687,297, D700,839, D715,649, and D730,174, and U.S. Design patent application Nos. 29/477,257, 29/493,539, and 29/498,477, the disclosures of which are each incorporated by reference herein in their entirety.

Although the container designs and base structures of these applications successfully provide containers that are sufficiently strong to permit puncturing of the base of the container, such containers may be brittle, such that breakage, cracking, and chad formation may result upon puncture. Thus, the present disclosure is directed to containers that are sufficiently punctureable but also that resist undesired breakage, cracking, and chad formation.

In certain embodiments, such container is formed of a layered material film formed of a first material layer and a second material layer having distinct material properties to provide desired container performance. The first material layer may be selected to provide the desired structural characteristics of the container. The second material layer may be disposed adjacent the first material layer and form the innermost layer of the container adjacent the cavity formed by the sidewall. In particular, the second material layer may be a skim coat layer. As used herein, the phrases “skim coat” and “skim layer” are used interchangeably to refer to a thin layer disposed on the first material layer and having a different majority polymer component than the first material layer. As used herein, a “majority component” is the component that is present in the greatest quantity in the relevant layer.

The skim coat may have a skim coating thickness from about 0.25 to about 25 percent of the thickness of the total thickness of the film material (i.e., the first and second material layers). For example, the skim coating thickness may be from about 1 mil to about 8 mils, from about 1 mil to about 6 mils, from about 1.5 mils to about 4 mils, or from about 2 mils to about 3.5 mils.

In certain embodiments, the skim layer is formed of a material that is softer and/or has a lower melting point than the first material layer. For example, the skim layer may beneficially act as a flexure bearing or living hinge for the first material layer, preventing breakage of the potentially brittle first material layer upon puncture. Additionally, the skim layer may beneficially be formed of a material that provides a suitable sealing surface for a filter and/or lid of the container.

In certain embodiments, the container is formed of a first material layer that provides the desired structural properties for the containers. Such first material layer may be a monolayer or multilayer material and may be thermoplastic in nature. Desirably, the first material layer is substantially impermeable and imperforate. For example, the first material layer may be a material monolayer or multilayer film material as described in U.S. Patent Application Publications No. 2014/0120217, 2014/0120218, and 2014/0308406, or PCT Application Publication No. WO 2015/191565, which are incorporated by reference herein.

One or more layers of the first material layer may contain at least one thermoplastic material. Non-limiting examples of suitable thermoplastic materials contained in the first material layer include polyolefins such as polypropylene (e.g., a polypropylene homopolymer or copolymer) and polyethylene, polystyrene, nylon, and other polymers. In particular embodiments, the first material layer contains a thermoplastic material that is a bio-based resin, readily recyclable, and/or that is formed of at least a portion of recycled material. For example, the first material layer may contain a thermoplastic material that contains a recycled polypropylene base resin. As used herein, the term “recyclable” refers to the container or one or more layers thereof being recyclable under the definition set forth by the Federal Trade Commission in their Final Rule on Guides for the Use of Environmental Marking Claims, 16 C.F.R. Part 260.

In embodiments, the thermoplastic material of the one or more layers of the first material layer may be blended with one or more additives to impart the desired mechanical and thermal properties to the container. For example, in embodiments the thermoplastic material may be blended with one or more additives to impart the desired stiffness to the container. In an embodiment, the additive includes an immiscible polymer that may function as a stress concentrator by hindering the natural ability of the thermoplastic material to deform plastically and promoting controlled crack propagation. Non-limiting examples of immiscible polymers that may be suitable for use with a thermoplastic material containing polypropylene include acrylics, styrenics, or their blends and copolymers with polyolefins. In an embodiment, the additive is a nucleating agent. In an embodiment, a second additive includes a metallic stearate, non-limiting examples of which include calcium stearate, magnesium stearate, zinc stearate, and combinations thereof. Other non-limiting examples of additives include inorganic fillers such as titanium dioxide, wollastonite, mica, kaolin, calcium carbonate, talc, clays, and nano grades and any combinations of these additives. These additives may be provided in raw form or may be provided in a resin or other carrier. For example, the talc may be 60% talc in a polypropylene homopolymer or other resin. For example, the titanium dioxide may be 60% TiO₂ in a resin.

In embodiments, at least one layer of the first material layer contains a blend of a thermoplastic polymer, a nucleating agent, and a second additive selected from the group consisting of calcium carbonate, talc, clay, and combinations thereof. For example, the nucleating agent may be present in the layer in an amount from about 0.5 to about 5 percent by weight of the at least one layer or about 0.5 to about 2.5 percent by weight of the at least one layer, and the second additive may be present in an amount from about 5 to about 25 percent by weight of the at least one layer, about 5 to about 20 percent by weight of the at least one layer, about 7 to about 18 percent by weight of the at least one layer, about 7 to about 12 percent by weight of the at least one layer, or about 9 percent by weight of the at least one layer.

In some embodiments, the first material layer is a monolayer containing polypropylene homopolymer in an amount of at least 70 percent by weight or is a multilayer material in which at least one layer contains a polypropylene homopolymer in an amount of at least 70 percent by weight of the at least one layer. For example, the monolayer of polypropylene homopolymer or the at least one layer of the multilayer material containing the polypropylene homopolymer may contain the polypropylene homopolymer in an amount from at least 70 up to 97 percent by weight of the layer, a nucleating agent in an amount from 0.5 to 5 percent by weight of the layer, and a second additive (e.g., talc or a talc containing resin) in an amount from 3 to 15 percent by weight of the layer. In certain embodiments, the monolayer of polypropylene homopolymer or the at least one layer of the multilayer material containing the polypropylene homopolymer may contain the polypropylene homopolymer in an amount from at least 80 up to 97 percent by weight of the layer, a nucleating agent in an amount from 1 to 3 percent by weight of the layer, and a second additive (e.g., talc or a talc containing resin) in an amount from 5 to 15 percent by weight of the layer. For example, the monolayer of polypropylene homopolymer or the at least one layer of the multilayer material containing the polypropylene homopolymer may contain the polypropylene homopolymer in an amount from at least 80 up to 90 percent by weight of the layer, a nucleating agent in an amount from 1.5 to 2.5 percent by weight of the layer, and a second additive (e.g., talc or a talc containing resin) in an amount from 7 to 15 percent by weight of the layer.

In embodiments in which the first material layer is a multilayer material having at least two layers, the multilayer material may include layers in addition to the layer containing the thermoplastic polymer material (e.g., polypropylene homopolymer). For example, the multilayer material may include a barrier layer configured to improve the barrier properties of the first material layer. Non-limiting examples of barrier layers commonly used in the art include ethylene vinyl alcohol (EVOH) and nylon, with the amount of the additive in the barrier layer being determined at least in part by the particular application for which the container will be used.

The multilayer material of the first material layer also may include one or more tie layers disposed between the barrier layer and the adjacent layers, one or more layers of regrind, and/or one or more buffer layers adjacent to the thermoplastic layer(s) and containing the same thermoplastic material as the thermoplastic layer. For example, the tie layer(s) may include an adhesive resin, such as a modified polyolefin adhesive resin. For example, the regrind layer(s) may include thermoplastic material that has been processed at least once before, such as pre-consumer material, including plastic materials from containers, web scrap, and/or sheet edge trim from the manufacturing of the containers described herein.

For example, the buffer layer(s) may include materials similar to those in the thermoplastic layer(s), including a thermoplastic polymer such as polypropylene (e.g., polypropylene homopolymer), a nucleating agent, and one or more additional additives (e.g., talc or the other inorganic fillers discussed herein, or resins containing the same). In some embodiments, the buffer layer(s) include the same thermoplastic polymer contained in the thermoplastic layer(s), but in a lower percentage by weight of the layer. For example, in one embodiment, the first material layer is a multilayer material in which the thermoplastic layer contains the polypropylene homopolymer in an amount of from about 70 percent to about 100 percent by weight of the at least one layer and the buffer layer contains the polypropylene homopolymer in an amount from at least 65 percent up to 97 percent by weight of the layer, a nucleating agent in an amount from 0.5 to 5 percent by weight of the layer, and talc in an amount from 3 to 15 percent by weight of the layer.

For example, the first material layer may be a multilayered film having five (5) layers: thermoplastic polymer/tie layer/barrier layer/tie layer/thermoplastic polymer layer. For example, the thermoplastic polymer layer may contain a polypropylene homopolymer and the barrier layer may include EVOH. In another embodiment, the first material layer is a multilayered film having seven (7) layers: thermoplastic polymer/regrind/tie layer/barrier layer/tie layer/regrind/thermoplastic polymer. In yet another embodiment, the first material layer is a multilayered film having eight (8) layers: thermoplastic polymer/buffer/regrind/tie layer/barrier layer/tie layer/buffer/thermoplastic polymer. Thus, in certain embodiments the first material layer is asymmetric in its layer structure.

The second material layer, or skim coat layer, may be selected to be softer and/or more flexible than the first material layer. For example, the skim coat layer may predominantly contain a material having a lower melting point then the majority component of the thermoplastic layer of the first material layer.

In certain embodiments, the first material layer is a monolayer containing polypropylene homopolymer in an amount of at least 70 percent by weight or is a multilayer material in which at least one layer contains a polypropylene homopolymer in an amount of at least 70 percent by weight of the at least one layer and the second material layer contains a polypropylene copolymer in an amount of at least 60 percent by weight of the second material layer. For example, the polypropylene copolymer may be a polypropylene impact copolymer or a polypropylene random copolymer. Polypropylene random copolymers are thermoplastic resins produced through the polymerization of propylene, with ethylene or butene bonds introduced in the polymer chain, whereas polypropylene impact copolymers are thermoplastic resins produced through the polymerization of propylene and ethylene by using Ziegler Natta catalysts. Due to their relatively low melting points, such polypropylene copolymers are traditionally used for cold temperature applications and not in applications in which hot or boiling water is in contact with the material.

In certain embodiments, the second material layer contains the polypropylene copolymer in an amount of at least 75 percent by weight of the second material layer, or in an amount of from 75 percent by weight to 100 percent by weight of the second material layer. For example, the second material layer may contain the polypropylene copolymer in an amount of about 80 percent by weight, about 85 percent by weight, about 90 percent by weight, about 95 percent by weight, or 100 percent by weight of the second material layer.

In some embodiments, the second material layer further contains a polyolefin based plastomer or elastomer in an amount of about 5 percent to about 25 percent by weight of the second material layer.

As discussed above, in certain embodiments the skim coat layer (i.e., the second material layer) has a skim coating thickness from about 0.25 to about 25 percent of the thickness of the total thickness of the film material (i.e., the first and second material layers). For example, the second material layer may have a thickness that is from about 0.5 percent to about 20 percent of a total thickness of the film material, or from about 5 percent to about 15 percent of a total thickness of the film material.

In some embodiments, the second material layer is positioned adjacent the monolayer of polypropylene homopolymer or the at least one layer containing the polypropylene homopolymer of the multilayer material, with no tie layer being disposed therebetween. That is, the second material layer may be adhered to the first material layer without the use of a tie layer. In certain embodiments, the skim layer contains minimal or no additives. For example, the skim layer may contain polyolefin polymer(s) in an amount of at least 95 percent by weight. Because the skim coat layer forms the innermost layer of the container that interacts with the food or other product contained therein, it may be desirable to limit the amount of additives in this layer. Additionally, limiting the amount of additives in this layer may improve the recyclability of the container in consumer recycling facilities.

In certain embodiments, the regrind layer contains a blend of the regrind materials discussed above as well as up to about 20 percent by weight of the materials forming the second material layer, in an equivalent ratio as provided in the second material layer. In certain embodiments, the regrind layer contains up to about 15 percent, or up to about 11 percent, such as about 11 percent, or about 7 percent, by weight of the materials forming the second material layer, in an equivalent ratio as provided in the second material layer. In one embodiment, the at least one regrind layer contains the polypropylene copolymer present in the skim layer in an amount of at least 5 percent by weight of the regrind layer.

Sheet stock materials for use in the formation of such containers are also provided herein and may include any of the layer structures described herein. In certain embodiments, the sheet stock material includes a first material layer that is a monolayer or multilayer material and is configured to provide the desired structural properties to the container, as well as a second material layer (i.e., skim coat layer) disposed adjacent the first material layer. In certain embodiments, the first material layer is a monolayer of polypropylene homopolymer in an amount of at least 70 percent by weight, or a multilayer material in which at least one layer contains a polypropylene homopolymer in an amount of at least 70 percent by weight of the at least one layer. In certain embodiments, the second material layer contains a polypropylene copolymer in an amount of at least 60 percent by weight of the second material layer.

The sheet stock material may be formed to have a desired total thickness and desired thicknesses of the individual layers forming the first and second material layers that are suitable for the particular application of the sheet stock material. For example, the total thickness of the sheet stock film material may be from about 20 mils to about 100 mils, from about 30 mils to about 60 mils, from about 35 mils to about 55 mils, or about 45 mils. For example, the skim coat layer may make up from about 3 percent to about 15 percent, from about 4 percent to about 10 percent, or from about 4 percent to about 7 percent of the total thickness of the sheet stock film material. For example, the skim coating thickness may be from about 1 mil to about 8 mils, from about 1 mil to about 6 mils, from about 1.5 mils to about 4 mils, or from about 2 mils to about 3.5 mils.

The containers described herein may be formed from the sheet stock material by a variety of processes that will be described in more detail below. In certain embodiments, the skim coat layer forms the interior surface of the container while an outer layer/surface of the first material layer forms the outer surface of the container. For example, a layer containing the thermoplastic polymer, such as the polypropylene homopolymer may form the outer surface of the container.

Containers formed by the sheet stock material may have a substantially circular base defining a puncture region and a frustoconically shaped wall extending from an edge of the base and defining a cavity therein. As discussed above, the cup-shaped containers may include a variety of base designs or configurations that serve to enhance the rigidity and resulting punctureability of the base of the container.

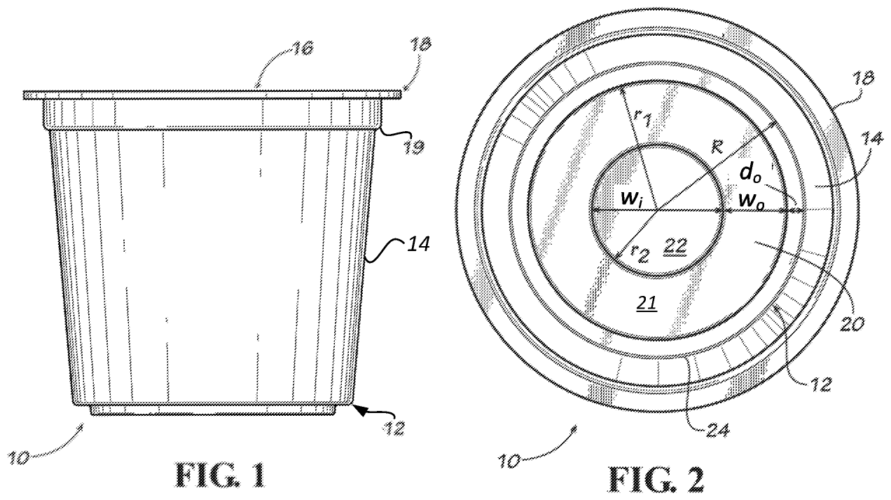

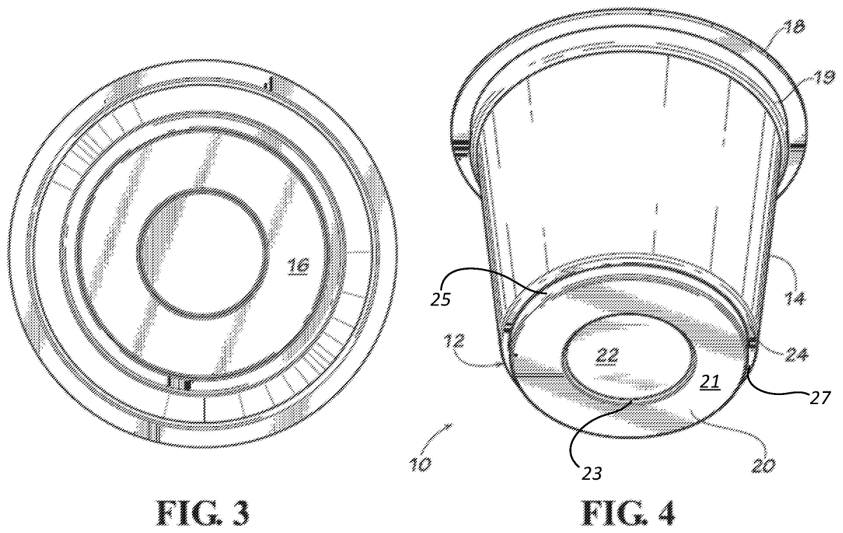

In one embodiment, the base includes an annular support structure, such as described in U.S. Patent Application Publication No. 2014/0308406, which is incorporated by reference herein. The annular support structure desirably is positioned an effective distance from the edge of the base to increase the punctureability of the base. An exemplary embodiment of a container 10 is illustrated in FIGS. 1-5. The container 10 includes a base 12 and a frustoconically shaped sidewall 14 defining an opening 16. The sidewall 14 may include a radially outwardly protruding lip 18 surrounding the opening 16. In one aspect, the radially outwardly protruding lip 18 further includes a stacking shoulder 19 that intersects and extends laterally from the sidewall 14. The base 12 includes an annular support structure 20 with a continuous region 22 therein. The annular support structure 20 desirably is positioned an effective distance away from the edge 24 of the base 12.

The annular support structure 20 is configured to permit the puncture of the container base at any position in the annular support structure 20 or in the continuous region 22 during preparation of the beverage. Although the presently described embodiment of annular support structure 20 is an annular shape, other shapes also may be used (e.g., elliptical, triangular, square, hexagonal, heptagonal, octagonal, and the like), provided the structure does not interfere with puncturing of the base and is positioned an effective distance from the edge 24 of the base.

In embodiments, the annular support structure may include more than one annular shape. For example, the annular support structure may include a first annular shape and a second annular shape positioned inside the first annular shape. In embodiments, the first annular support structure and the second annular support structure have substantially the same dimensions (i.e., width and height). Those skilled in the art will appreciate, however, that the dimensions of the first annular support structure and second annular support structure may be different (i.e., different widths and the like).

Not wishing to be bound by any theory, the position of the annular support structure an effective distance from the edge of the base changes the mode of failure of the container and increases the rigidity of the base, thereby improving the punctureability of the base. In exemplary embodiments, an effective distance from the edge of the base is from about 1 to about 10 mm, from about 1 to about 5 mm, from about 1.5 to about 2.5 mm, or from about 2.0 to about 2.5 mm. For example, in an embodiment the annular support structure may be positioned about 2.3 mm from the edge of the base.

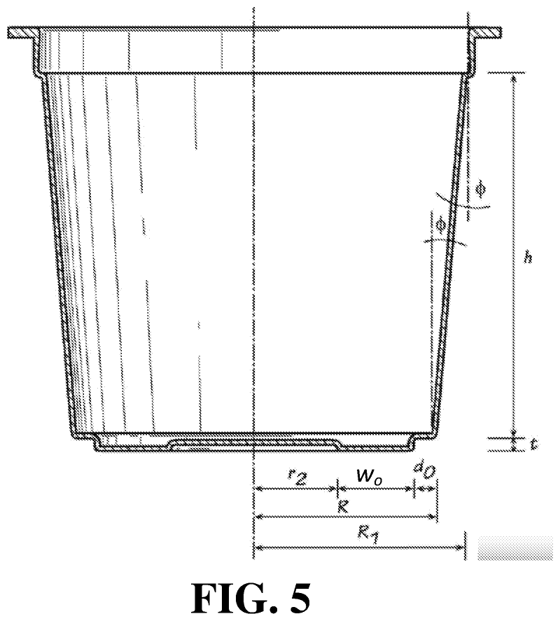

In an embodiment, as shown in FIG. 5, the container may be further characterized by the following mathematical relationship:

h=(R₁−R)·tan(90−Φ)

wherein h is the height of the container from the base 12 to the stacking shoulder 19, R₁ is the inner radius of the container at the stacking shoulder 19, R is the radius of the base 12 at the edge 24 of the base, and Φ is the approach angle.

The container also can further be characterized by the dimensions of the base features (FIG. 2 and FIG. 5): r₁ is the radius of the base 12 to the outer portion of the annular support structure 20, r₂ is the radius of the base 12 to the inner portion of the annular support structure 20, dₒ is the effective distance from the edge 24 of the base to the annular support structure 20, wₒ is the width of the annular support structure 20, wᵢ is the width (i.e., diameter) of the continuous region 22 of the base 12, and t is the height of the annular support structure 20. Accordingly, in certain embodiments the base 12 is further characterized by the following mathematical relationships:

dₒ=R−r₁>0.01

wₒ=r₁−r₂>0.01

R>r₁>r₂

wᵢ=2−r₂

In embodiments, r₁ and r₂, independent from one another, may be from about 0.1 to about 10.0 mm. For example, in embodiments h may be from about 30 mm to about 75 mm, from about 30 mm to about 60 mm, about 35 mm to about 45 mm, or about 38 mm, R may be from about 10 mm to about 30 mm, from about 15 mm to about 25 mm, or about 18 mm, r₁ may be from about 9 mm to about 29 mm, from about 8 to about 20 mm, or about 16 mm, and r₂ may be from about 1 mm to about 28 mm, from about 5 mm to about 15 mm, or about 8 mm, such that dₒ is from about 1 mm to about 20 mm, from about 1 mm to about 5 mm, from about 1 mm to about 3 mm, or about 2.5 mm, wₒ is from about 1 mm to about 25 mm, from about 3 mm to about 15 mm, from about 3 mm to about 10 mm, or about 8 mm, wᵢ is from about 2 mm to about 56 mm, from about 10 mm to about 30 mm, or about 16 mm, and t is from about 0.25 mm to about 5 mm, from about 0.5 mm to about 3 mm, or about 1.25 mm. In certain embodiments, the ratio of the height of the annular support structure (t) to the height of the container (h) is from 0.5:100 to 5:100, such as from 2:100 to 4:100, or about 3:100. For example, in one embodiment, the base includes an annular support structure positioned from 0.5 mm to 3 mm from the edge of the base, having a width of from 5 mm to 10 mm, and having a height from 0.5 mm to 3 mm, relative to the edge of the base.

In certain embodiments, as shown in FIGS. 2, 4, and 5, the annular support structure 20 has a support surface 21 having the width (wₒ), with the support surface 21 being disposed in a plane parallel to a plane in which the continuous region 22 of the base 10 is disposed. In some embodiments, as shown in FIG. 4, the annular support structure 20 includes an inner sidewall 23 extending between the continuous region 22 of the base 10 and the support surface 21. In some embodiments, the annular support structure 20 further includes an outer sidewall 25 that extends perpendicularly from the support surface 21, with the outer sidewall 25 being positioned from 0.5 mm to 10 mm from the edge 24 of the base 10 (i.e., the effective distance from the edge). In some embodiment, the base 10 also includes an annular wall 27 extending between the outer sidewall 25 of the annular support structure 20 and the edge 24 of the base 10, with the annular wall being disposed in a plane parallel to a plane in which the support surface 21 of the annular support structure 20 is disposed.

In other embodiments (not illustrated), the base of the container includes an outer peripheral support structure in an annular shape having a plurality of recesses similar in appearance to an inverted parapet (i.e., castle-like structure of a battlement or crenellation), such as described in U.S. Patent Application Publications No. 2014/0120217 and 2014/0120218, which are incorporated by reference herein. That is, the outer peripheral support structure may be positioned at the edge of the base of the container. In certain embodiments, the base also includes inner support structure in an annular shape or a circular shape within the outer peripheral support structure.

In an embodiment, the container may be further characterized by the following mathematical relationship:

h=(R₁−R)·tan(90−Φ)

wherein h is the height of the container from the base to the stacking shoulder, R₁ is the inner radius of the container at the stacking shoulder, R is the radius of the base including the outer peripheral support structure, and Φ is the approach angle.

The container can further be characterized by the dimensions of the base features: r is the radius of the base excluding the outer peripheral support structure, r₁ is the inner radius of the optional inner support structure having an annular shape, r₂ is the outer radius of the optional inner support structure, wₒ is the width of the outer peripheral support structure, d is the width of the continuous region of the base, wᵢ is the width of the inner support structure having an annular shape, and t is the height of the outer peripheral support structure.

Accordingly, in certain embodiments the base is further characterized by the following mathematical relationships:

wₒ=R−r

wᵢ=r₂−r₁

d=½·t=r−r₂

In embodiments, r₁ and r₂, independent from one another, may be from about 0.0 to about 40.0 mm. For example, in embodiments in which the inner support structure has a circular shape with only a single radius, r₁ is zero and wᵢ=r₂, which may be from about 0.01 to about 5.0 mm. In embodiments in which the inner support structure includes an annular ring, r₂>r₁ and r₁ and r₂, independent from one another, may be from about 0.01 to about 5.0 mm. For example, r₁ may be 3.8 mm and r₂ may be 1.3 mm such that wᵢ is 2.5 mm. In embodiments in which there is no inner support structure, wᵢ, r₁, and r₂ are 0.0.

The outer peripheral support structure can still further be characterized by the feature angle (θ₀), the recess angle (θ₁), and the number of features (n), which have the following relationships:

θ₀=(360÷n)−θ₁

0<θ₁<θ₀

In embodiments, the height of the outer peripheral support structure (t) is from about 0.5 to about 2.5 mm, the height of the container (h) from the base to the stacking shoulder is from about 30 mm to about 45 mm, and the radius of the base (R) is from about 10 mm to about 20 mm. In an embodiment, the approach angle is from about 2 degrees to about 10 degrees. In certain embodiments, the outer peripheral support structure contains between 1 and 50 recesses therein, such as from about 10 to 30 recesses.

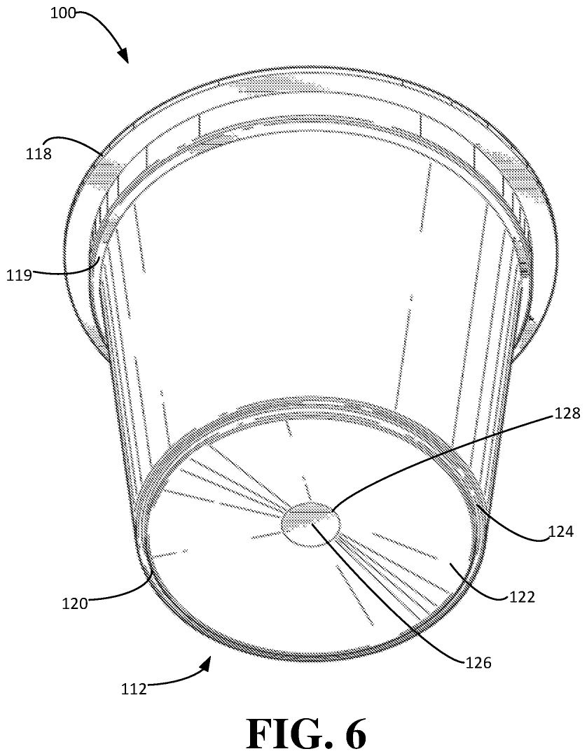

In yet further embodiments, as illustrated at FIGS. 6-8, the base 112 of container 110 includes an outer support structure 120 surrounding a continuous puncture region 122, with the outer support structure 120 being positioned an effective distance away from the edge 124 of the base 112, such as described in PCT Application Publication No. WO 2015/191565, which is incorporated by reference herein. The continuous puncture region 122 disposed inside the outer support structure 120 is configured to permit the puncture of the container base 112 at any position in the continuous puncture region 122 during preparation of the beverage without regard for the position of the puncture region.

Not wishing to be bound by any theory, the position of the outer support structure an effective distance from the edge of the base changes the mode of failure of the container and increases the rigidity of the base, thereby improving the punctureability of the base in the continuous puncture region. In exemplary embodiments, an effective distance from the edge of the base is from about 0.5 to about 10 mm, from about 1 to about 10 mm, from about 1 to about 5 mm, from about 1.5 to about 2.5 mm, or from about 2.0 to about 2.5 mm. For example, in an embodiment the outer support structure may be positioned about 2.3 mm from the edge of the base.

The continuous puncture region 122 may be inwardly sloping from horizontal towards the center 126 of the container base 112 (i.e., forming a cone-like shape). In embodiments, the continuous puncture region 122 may extend to the center 126 of the container base 112 (i.e., forming an apex of the cone) or may plateau into a flat region 128 at the center 126 of the container base 112. As used herein, the term “horizontal” refers to the plane that is perpendicular the longitudinal axis of the container (i.e., the center line extending through the center 126 of the container base to the center of the opening 116 of the container).

In an embodiment, shown in FIGS. 6-8, the container may be further characterized by the following mathematical relationship:

h=(R₁−R)·tan(90−Φ)

wherein h is the height of the container from the base 112 to the stacking shoulder 119, R₁ is the inner radius of the container at the stacking shoulder 119, R is the radius of the base 112 at the edge 124 of the base, and Φ is the approach angle.

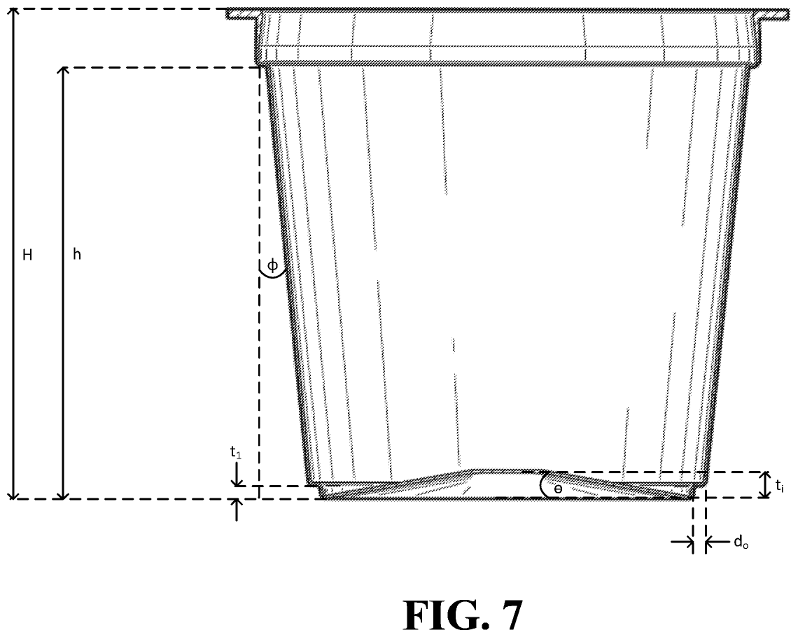

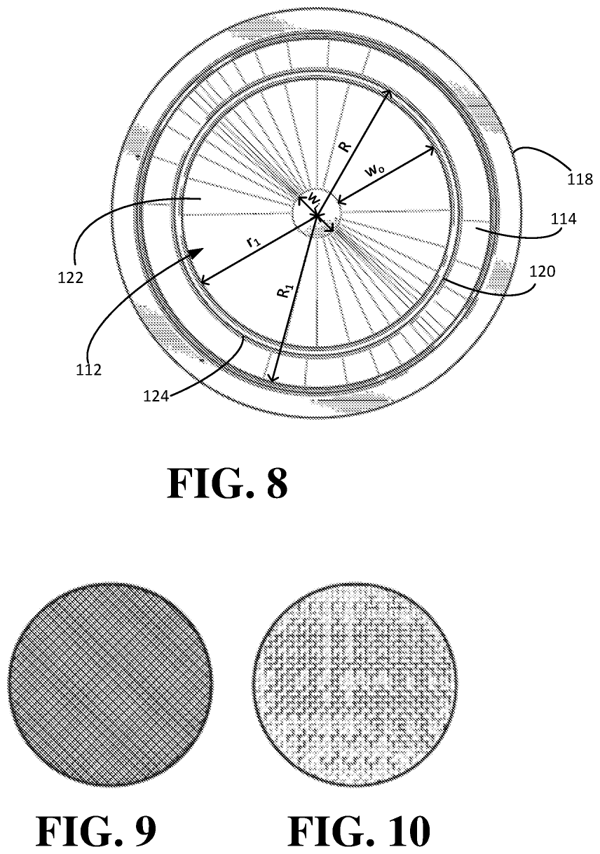

The container also can further be characterized by the dimensions of the base features (FIGS. 7 and 8): r₁ is the radius of the base 112 to the outer support structure 120, dₒ is the effective distance from the edge 124 of the base to the outer support structure 120, wᵢ is the width of the flat region 128, wₒ is the width of the continuous puncture region 122 of the base 112, t₁ is the height of the outer support structure 120, relative the edge 124 of the base, tᵢ is the height of the center 126 of the base 112, relative the bottommost portion of the outer support structure 120, and θ is the taper angle of the base 112. Accordingly, in certain embodiments the base 112 is further characterized by the following mathematical relationships:

dₒ=R−r₁>0.01

R>r₁

wₒ=r₁−½wᵢ

In an exemplary embodiment, the outer support structure may be disposed about 0.5 mm to about 10 mm, about 0.5 mm to about 5 mm, about 0.5 mm to about 2 mm, or about 0.75 mm to about 1.5 mm from the edge of the base (dₒ), the approach angle (Φ) may be from about 1 to about 10 degrees, the flat region may have a width (wᵢ) from about 0.0 mm to about 16 mm, or from about 5.0 mm to about 10.0 mm, the height (tᵢ) at the center of the base may be from about 0.05 mm to about 5 mm, from about 0.25 mm to about 3 mm, or from about 0.5 mm to about 3 mm, and the taper angle (θ) may be from about 0.5 degrees to about 10 degrees, from about 1 degree to about 5 degrees, or about 3.2 degrees relative to horizontal. For example, in an embodiment the outer support structure may be disposed about 1.1 mm from the edge of the base (dₒ), the taper angle (θ) may be about 3.2 degrees relative to horizontal, the flat region may have a width (wᵢ) of about 6.0 mm, and the height (tᵢ) at the center of the base may be about 0.75 mm. In certain embodiments, the inwardly sloping continuous puncture region includes a step at which the taper angle changes.

In embodiments of any of the foregoing container designs, the container further includes other features to facilitate the punctureability of the base in the continuous puncture region. For example, in an embodiment the container may include a feature in the inner or outer surface of the base of the container. The feature may be effective to weaken the material of the base in the continuous puncture region during its puncture without sacrificing its strength, for example, by providing stress concentrators. Two exemplary embodiments of the feature are illustrated in FIGS. 9 and 10, which illustrate the designs that may be imprinted in the inner surface of the base of the container. For example, imprinting may be done by thermoforming the container against a relief of the pattern during cup formation. Other designs also may be used.

In embodiments, a self-supporting filter element (not illustrated) known to those skilled in the art may be disposed in the container and either removably or permanently joined to an interior surface of the container. For example, the filter may be in the shape of an inverted hollow cone having a curved wall tapering evenly from a rim surrounding an opening. The filter element then may be placed in the container so that the apex of the cone is supported on and slightly flattened by the base of the container, thereby enlarging the volume within the cone and providing beneficial support for the filter element.

In embodiments, the container may be configured to receive an insert, such as the filter element or an additional insert, in which the dry beverage ingredients are disposed. For example, the container may be configured to receive an insert including a filter cup in which are disposed the ingredients for preparing a beverage. For example, the container may further include a filter cup containing a brew substance, non-limiting examples of which include coffee grinds, ground tea leaves, chocolate, flavored powders, and the like. The brew substance also may include a combination of dry milk, sugar or sugar substitute, or other flavorings to enhance the quality of the resulting beverage.

In embodiments, the container provided herein further includes a pierceable cover in a hermetically sealed relationship with the lip of the container, closing the opening to form a cartridge. The cover desirably is formed of an impermeable and imperforate material that may be pierced with an instrument, such as a tubular needle, through which hot water is delivered for preparation of the beverage. For example, in embodiments the cover may include e a polymer film or a foil heat-sealed to the lip of the container.

Thus, in certain embodiments, a container for forming a beverage includes any of the containers described herein, as well as a filter disposed in the cavity of the container and defining first and second chambers in the cavity, a beverage medium disposed in the cavity and arranged to interact with a liquid introduced into the container to form a beverage, and a lid attached to a rim of the container to contain the beverage medium and filter disposed therein.

In certain embodiments, the frustoconically shaped wall is free of radial protrusions or shoulders other than the stacking shoulder.

The containers embodied herein are particularly suited for use in an automatic machine, such as a coffee brewing machine. Upon placing the container in the machine, a piercing member punctures the cover to introduce pressurized hot water through the hole where it comes into contact with the beverage ingredients disposed in the filter. A second piercing member punctures the base of the container at any position in the base to enable the prepared beverage to flow out of the container and be dispensed into a cup or container for consumption by the consumer.

Desirably, the containers provided herein have a puncture load of less than about 6 kg. As used herein, the “puncture load” means the force required to puncture the base of the container using a single needle. It should be appreciated that the puncture load depends in part on the type of needle used to measure the puncture load of a container. For example, the puncture load measured using a dull needle having a curved or rounded puncture point generally will be greater than the puncture load measured using a sharp needle having a pointed puncture point. For example, in embodiments the containers may have a puncture load measured using a sharp needle of less than about 3 kg, less than about 2.75 kg, or less than about 2.5 kg. In embodiments, the containers may have a puncture load measured using a sharp needle of about 4.2 to about 3 kg, about 2.99 to about 2.75 kg, or about 2.74 to about 2.5 kg. In embodiments, the containers may have a puncture load measured using a dull needle of less than about 5 kg. For example, the containers may have a puncture load measured using a dull needle of about 4.0 to about 5.0 kg.

The containers described herein may be formed of a sheet stock material that is selected such that the resulting container is recyclable at consumer recycling facilities. Additionally, such containers may advantageously provide improved punctureability in traditional single needle machines due to the container design, such as the base structure design, as well as improved resistance to cracking, breaking, and chad formation due to the material structure of the container, including the skim coat layer.

In certain embodiments, the container is a polypropylene-based container, which beneficially may be readily recyclable at commercial recycling facilities. Thus, containers of the present disclosure may be easily recycled and provide the punctureability of similar non-recyclable containers. Moreover, the skim coat layer provides improved resistance to the consequences of the brittleness of traditional recyclable materials (e.g., polypropylene) that may be used to form such containers. For example, the skim coat achieves a balance of the desired punctureability and resistance to cracking. That is, the skim coat does not negatively impact the punctureability of the container formed by the first material layer structure, but prevents uncontrolled cracking upon puncture. In certain embodiments, the containers of the present disclosure prevent the formation of chads by maintaining the attachment of any chads formed in the first material layer to the second material layer. Furthermore, the skim layer of the present disclosure provides an improved interior surface for sealing any filter, insert, and/or lid to the container. Typical container materials, especially in recyclable containers, may have a high degree of crystallinity and/or a higher heat resistance relative to the materials of the present skim coat layers, such that sealing to such materials is more difficult.

Methods of Making Containers

Methods of making containers having improved puncture characteristics are also provided herein. For example, the methods may be used to form containers having any combination of the properties and characteristics described herein. Suitable methods, including thermoforming, injection molding, and other methods known in the art may be used to manufacture containers from the sheet stock materials described herein.

In certain embodiments, the methods include providing a sheet stock material as described herein, heating the sheet stock material, and drawing the heated sheet stock material into a mold to form a container. The processes of making the sheet stock material and the thermoformed containers may be performed in series (i.e., in-line thermoforming) or independently (i.e., off-line thermoforming). For example, in certain embodiments, the material sheet stock may be stored for later processing of the sheet stock into the thermoformed container. In other embodiments, the thermoforming of the sheet stock material may be performed in-line to produce the desired thermoformed container shape.

The sheet stock material may be prepared using appropriate methods known to those skilled in the art. For example, the sheet stock material may be extruded or laminated using methods such as multimanifold die coextrusion, feedblock technology, extrusion coating, and thermal lamination. For example, the sheet stock material may be formed by coextruding the first and second material layers.

In certain embodiments, as discussed above, the sheet stock film material may have a total thickness in the range of from about 20 mils to about 100 mils, from about 30 mils to about 60 mils, from about 35 mils to about 55 mils, or about 45 mils. In the form of the sheet stock material (i.e., after formation of the sheet, but prior to thermoforming or other processing to form the container therefrom), the thickness of the sheet may be greater than the thickness of the container wall formed from the sheet stock material, due to the thermoforming or other processing.

In certain embodiments, as discussed above, the skim coat layer may make up from about 3 percent to about 15 percent, from about 4 percent to about 10 percent, or from about 4 percent to about 7 percent of the total thickness of the sheet stock film material. For example, in the sheet stock material, the skim coating thickness may be from about 1 mil to about 8 mils, from about 1 mil to about 6 mils, from about 1.5 mils to about 4 mils, or from about 2 mils to about 3.5 mils.

The foregoing embodiments can be further understood and illustrated by the following non-limiting examples.

### Example 1

Various sheet stock materials were produced in accordance with the present disclosure and thermoformed into containers of various structural designs. First, containers having three structural designs were prepared from four sheet stock material structures. The “Stock” shape refers to a container shape as shown in FIGS. 1-5, having an annular support structure on the base. The “Standard” shape refers to a container shape as shown in FIGS. 6-8, having a slightly conical base with a diameter that is smaller than the Stock container and a different sidewall angle. The “Blast” shape refers to a container shape that is the same as the Standard container, but has a patterned base with fine hashings, as shown in FIG. 9/10.

Containers having these shapes were manufactured from four sheet stock materials. Sheet stock “Std 4-19” was a polypropylene-based sheet stock material having no skim layer, containing a thermoplastic polypropylene homopolymer layer, a regrind layer, a tie layer, a barrier layer, a second tie layer, and a second thermoplastic polypropylene homopolymer layer. Sheet stock “53” was similar to the Std 4-19 structure, but included a skim layer forming 7 percent of the overall thickness of the sheet stock material, with the skim layer formed of 80 percent by weight of a polypropylene random copolymer, and 20 percent by weight of a polyolefin plastomer containing at least 98 percent by weight ethylene-1-octene copolymer, with equivalent relative amounts of the skim layer materials added to the regrind layer. Sheet stock “54” was similar to the Std 4-19 structure, but included a skim layer forming 10 percent of the overall thickness of the sheet stock material, with the skim layer formed of 80 percent by weight of a polypropylene random copolymer and 20 percent by weight of a polyolefin plastomer, with equivalent relative amounts of the skim layer materials added to the regrind layer. Sheet stock “55” was similar to the Std 4-19 structure, but included a skim layer forming 7 percent of the overall thickness of the sheet stock material, with the skim layer formed of 60 percent by weight of a polypropylene random copolymer and 40 percent by weight of a polyolefin plastomer, with equivalent relative amounts of the skim layer materials added to the regrind layer.

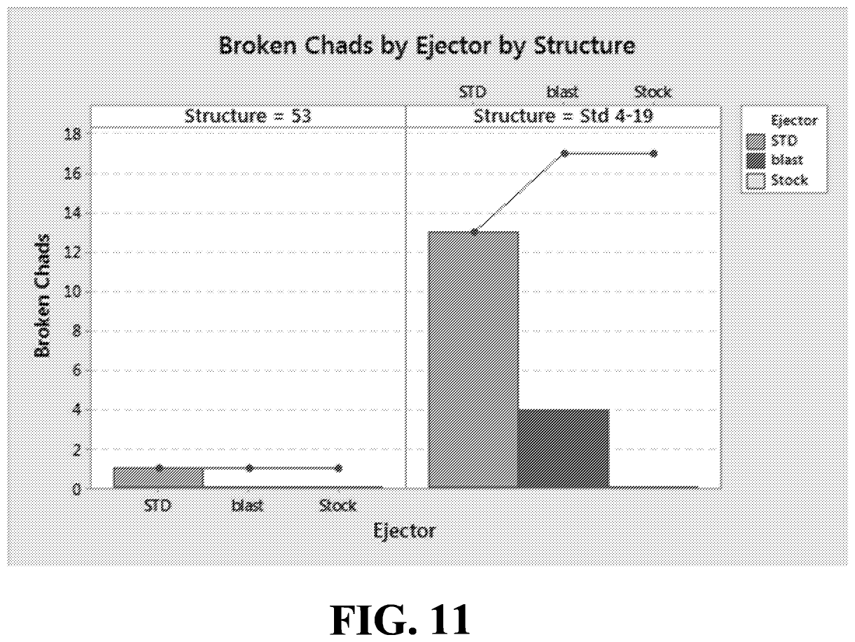

The containers were tested for various punctureability characteristics using a commercially available traditional single-serve brewing machine puncture mechanism. The results of these tests are shown in FIGS. 11-14. In particular, FIG. 11 is a graph showing the comparative results of the number of broken chads formed in containers formed of material Std 4-19 and 53, in each of the three container shapes. As can be seen, the containers having the skim coat displayed significantly fewer broken chads (i.e., chads that are fully disconnected from the container), with the containers in the Standard container shape having more broken chads than those in the Blast and Stock shapes.

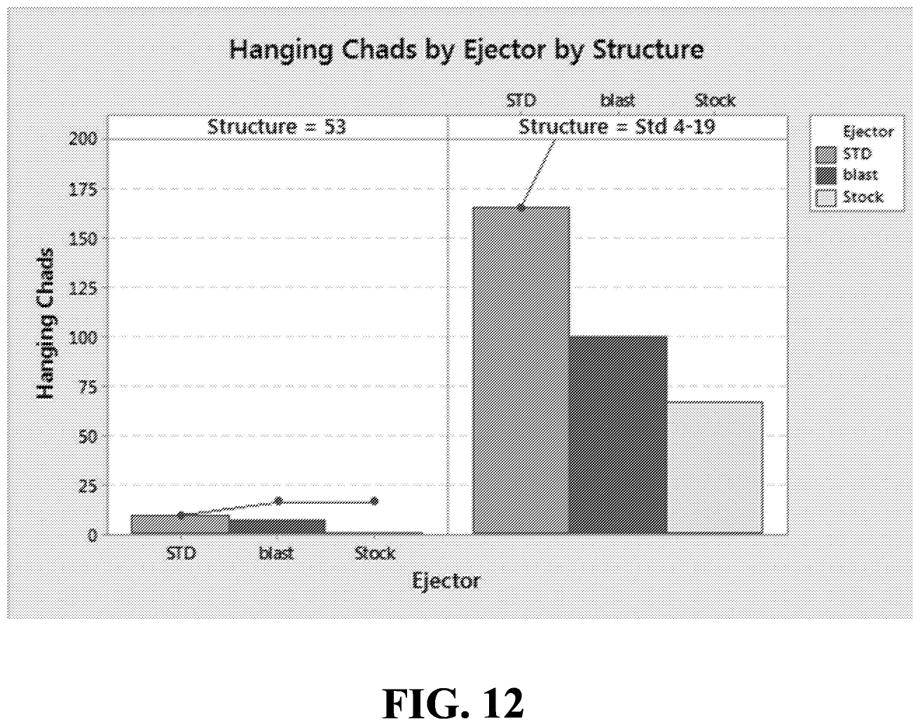

FIG. 12 is a graph showing the comparative results of the number of hanging chads formed in containers formed of material Std 4-19 and 53, in each of the three container shapes. As can be seen, the containers having the skim coat displayed significantly fewer hanging chads (i.e., chads that are not fully disconnected from the container), with the containers in the Standard container shape having more hanging chads than those in the Blast and Stock shapes.

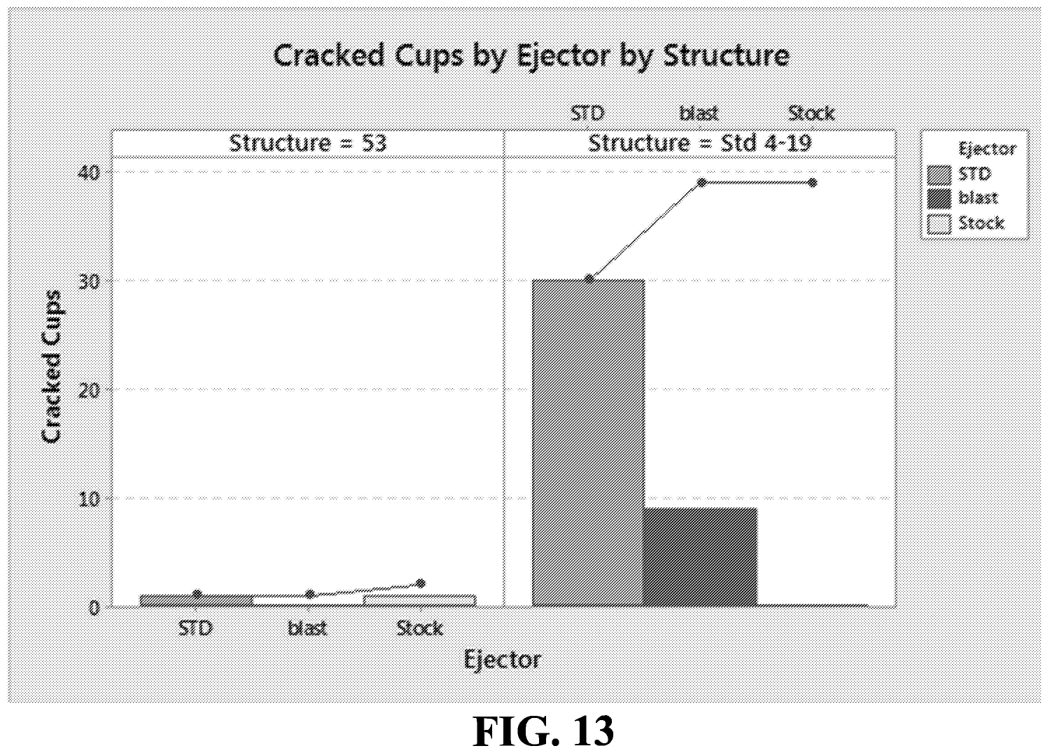

FIG. 13 is a graph showing the comparative results of the number of cracked cups resulting in containers formed of material Std 4-19 and 53, in each of the three container shapes. As can be seen, the containers having the skim coat displayed significantly fewer cracked cups (i.e., containers displaying any cracking other than the desired puncture hole), with the containers in the Standard container shape displaying a higher amount of cracked containers than those in the Blast and Stock shapes.

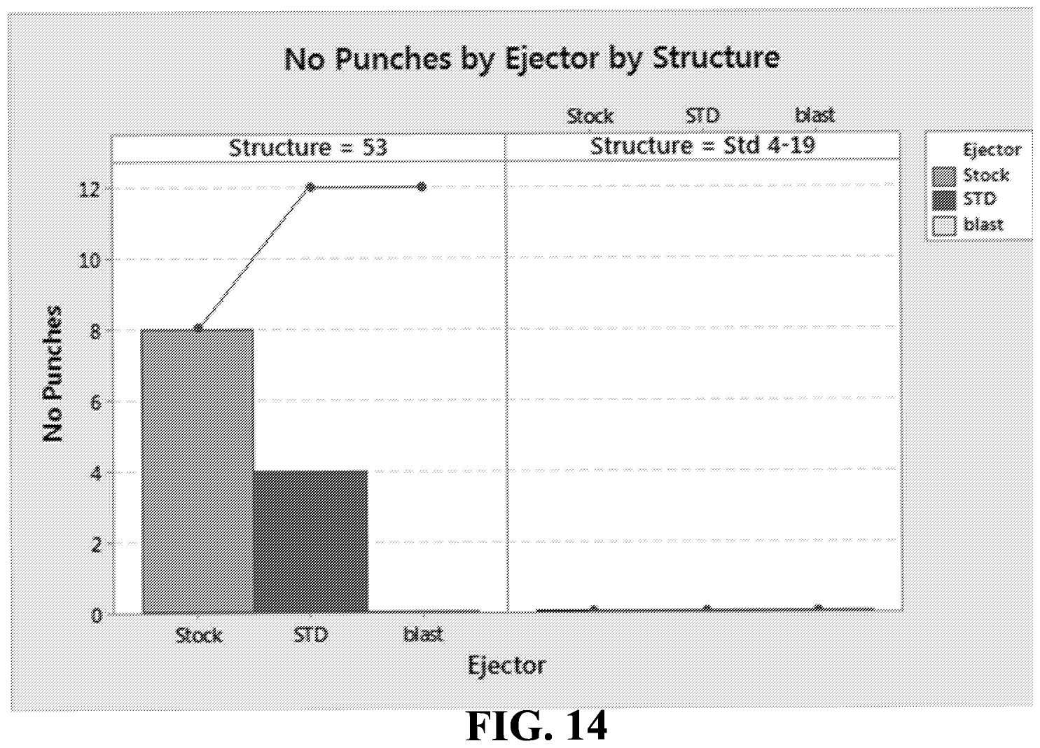

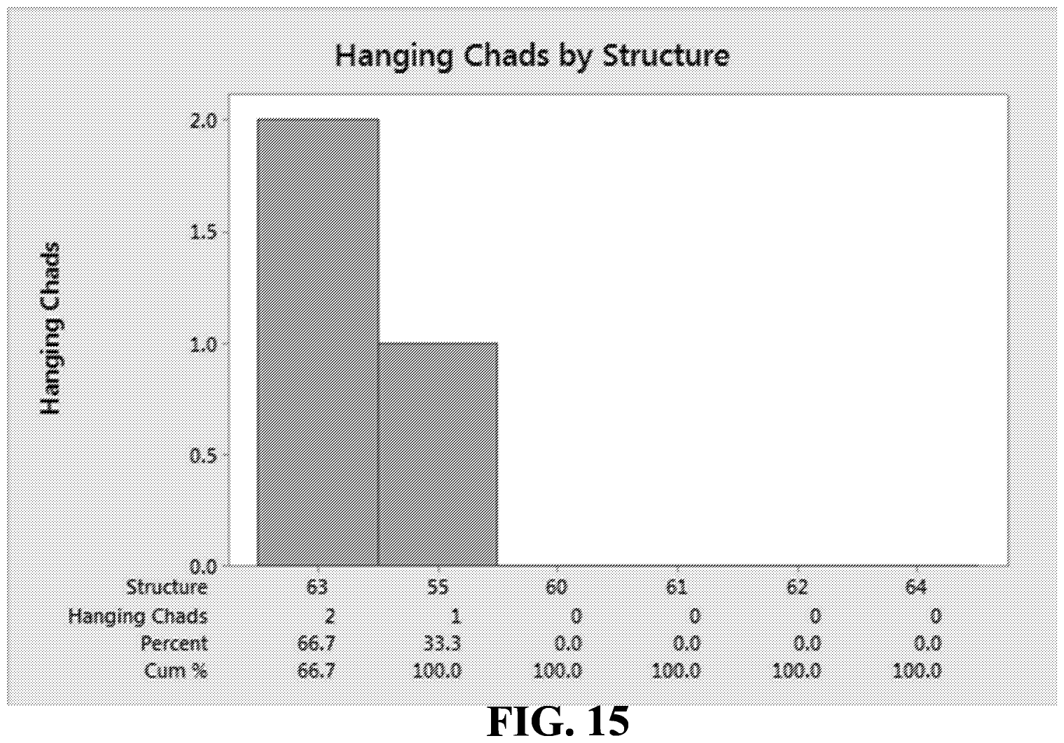

FIG. 14 is a graph showing the comparative results of the number of containers that did not puncture (punch) formed of material Std 4-19 and 53, in each of the three container shapes. As can be seen, the containers having the skim coat displayed a higher amount of non-punctured containers, with the containers in the Stock container shape displaying a higher amount of non-punctured containers than the Standard and Blast shapes. This is believed to be due to the increase in flexibility of the container resulting from the addition of the skim coat layer.

Containers formed from stock sheet material 54 in the Stock container shape were also formed and comparatively tested with Stock containers made from the Std 4-19 material structure. In summary, the Stock Structure 54 containers (47 Samples tested) displayed no broken chads, one hanging chad, three cracked cups, and a high amount of first punch non-punctured containers, similar to the results for container structure 53 reported above. Table 1 below shows the test results from the Stock Structure 54 and Stock Std 4-19 Containers.

TABLE 1
Comparative Test Results for Stock Structure 54 and Stock Std 4-19 Containers

| | | | | | | | | | | | | |
|---|---|---|---|---|---|---|---|---|---|---|---|---|
| | Elongation | Break | Elongation at | Peak | | Load | Extension At | Extension At | | | Break | Load At Offset |
| Test | At Break | Load | Peak | Load | Slack | At Yield | Offset Yield | Yield | Peak | Break | Stress | Yield |
| Unit | in | lbf | in | lbf | in | lbf | in | In | Index | Index | psi | lbf |

Stock Std 4-19 (30 Samples Tested)

| | | | | | | | | | | | | |
|---|---|---|---|---|---|---|---|---|---|---|---|---|
| Avg | 0.284 | 12.172 | 0.284 | 12.172 | 1.391 | 6.504 | 0.210 | 0.156 | 504.133 | 504.133 | 194.746 | 8.838 |
| Median | 0.280 | 12.038 | 0.280 | 12.038 | 1.390 | 4.960 | 0.207 | 0.136 | 503.500 | 503.500 | 192.607 | 7.909 |
| Std | 0.027 | 2.107 | 0.027 | 2.107 | 0.002 | 3.011 | 0.018 | 0.047 | 8.050 | 8.050 | 33.709 | 2.207 |
| Dev | | | | | | | | | | | | |
| Max | 0.334 | 15.814 | 0.334 | 15.814 | 1.396 | 15.247 | 0.259 | 0.309 | 519.000 | 519.000 | 253.031 | 13.902 |
| Min | 0.231 | 9.178 | 0.231 | 9.178 | 1.387 | 3.351 | 0.183 | 0.110 | 487.000 | 487.000 | 146.846 | 6.094 |

Stock Structure 54 (47 Samples Tested)

| | | | | | | | | | | | | |
|---|---|---|---|---|---|---|---|---|---|---|---|---|
| Avg | 0.360 | 13.463 | 0.359 | 13.809 | 1.378 | 7.853 | 0.254 | 0.200 | 522.766 | 519.633 | 215.406 | 9.219 |
| Median | 0.337 | 13.998 | 0.346 | 14.203 | 1.398 | 5.722 | 0.223 | 0.151 | 524.000 | 522.000 | 223.970 | 9.140 |
| Std | 0.159 | 1.847 | 0.126 | 1.864 | 0.131 | 4.893 | 0.131 | 0.099 | 6.126 | 5.599 | 29.549 | 2.163 |
| Dev | | | | | | | | | | | | |
| Max | 1.196 | 15.834 | 1.196 | 17.254 | 1.401 | 15.533 | 1.102 | 0.354 | 529.000 | 526.000 | 253.350 | 13.248 |
| Min | 0.276 | 9.256 | 0.276 | 9.256 | 0.499 | 0.194 | 0.192 | 0.002 | 504.000 | 504.000 | 148.092 | 5.245 |

### Example 2

Sheet stock materials were also manufactured with a variety of layer structures and compositions, as detailed in Tables 2 through 5 below. In the first trial, sheet stock having the structure and composition shown in Tables 2 and 3 were manufactured by coextrusion. This sheet stock had an asymmetric top (i.e., from the cap to the tie layer) and an asymmetric bottom (i.e., from the tie to the skim) layer structure.

TABLE 2
Trial 1 Sheet Stock Material Layer Structure

| | Layer | | | | | | | | |
|---|---|---|---|---|---|---|---|---|---|
| | Cap | Buffer | Tie | EVOH | Tie | Regrind | Buffer | Cap | Skim |
| Volume % | 12.2% | 12.2% | 1.5% | 4.0% | 1.5% | 37.2% | 12.2% | 12.2% | 7.0% |
| Mils | 5.5 | 5.5 | 0.7 | 1.8 | 0.7 | 16.8 | 5.5 | 5.5 | 3.2 |
| (Total | | | | | | | | | |
| 45.05) | | | | | | | | | |
| Min | | | 0.35 | 0.9 | 0.35 | | | | |

TABLE 3
Trial 1 Sheet Stock Material Composition

| Layer Composition | Weight % |
|---|---|
| Skim | |
| Impact polypropylene copolymer | 100.0 |
| Cap (Thermoplastic Polymer Layer) | |
| High melt strength polypropylene | 88.8 |
| homopolymer | |
| 60% TiO₂ in resin | 1.7 |
| 60% talc in a polypropylene homopolymer | 7.5 |
| Nucleating Agent | 2.0 |
| Buffer | |
| High melt strength polypropylene | 82.5 |
| homopolymer | |
| 60% TiO₂ in resin | 8.0 |
| 60% talc in a polypropylene homopolymer | 7.5 |
| Nucleating Agent | 2.0 |
| Regrind | |
| Regrind | 100.0 |
| Tie | |
| Modified polyolefin adhesive resin | 30.0 |
| High melt strength polypropylene | 70.0 |
| homopolymer | |
| Barrier (EVOH) | |
| Ethylene vinyl alcohol resin | 100.0 |

In the second trial, three sheet stock materials having the structure and composition shown in Tables 3 and 5 were manufactured by coextrusion. These sheet stock materials had an asymmetric top (i.e., from the cap to the tie layer) and an asymmetric bottom (i.e., from the tie to the skim) layer structure.

### Example 3

In the third trial, two sheet stock materials having the structure and composition shown in Tables 4 and 5 were manufactured by coextrusion. These sheet stock materials had an asymmetric top (i.e., from the cap to the tie layer) and an asymmetric bottom (i.e., from the tie to the skim) layer structure.

The goal of the second and third trials was to manufacture sheet stock material that could be used to manufacture containers having a reduced rate of non-puncture while maintaining the lack of chads demonstrated with the skim coat layer.

TABLE 3
Trial 2 Sheet Stock Material Layer Structure (For Samples 60, 62, 63)

| | Layer | | | | | | | | |
|---|---|---|---|---|---|---|---|---|---|
| | Skim | Cap | Buffer | Regrind | Tie | EVOH | Tie | Buffer | Cap |
| Volume % | 7.1% | 11.7% | 11.7% | 39.9% | 1.6% | 3.0% | 1.6% | 11.7% | 11.7% |
| Mils | 3.2 | 5.3 | 5.3 | 18.0 | 0.7 | 1.4 | 0.7 | 5.3 | 5.3 |
| (Total | | | | | | | | | |
| 45.15) | | | | | | | | | |
| Min | | | | | 0.35 | 0.9 | 0.35 | | |

TABLE 4
Trial 3 Sheet Stock Material Layer Structure (For Samples 61, 64)

| | Layer | | | | | | | | |
|---|---|---|---|---|---|---|---|---|---|
| | Skim | Cap | Buffer | Regrind | Tie | EVOH | Tie | Buffer | Cap |
| Volume % | 4.4% | 12.4% | 12.4% | 39.9% | 1.6% | 3.0% | 1.6% | 12.4% | 12.4% |
| Mils | 2.0 | 5.6 | 5.6 | 18.0 | 0.7 | 1.4 | 0.7 | 5.6 | 5.6 |
| (Total | | | | | | | | | |
| 45.15) | | | | | | | | | |
| Min | | | | | 0.35 | 0.9 | 0.35 | | |

TABLE 5
Trials 2 & 3 Sheet Stock Material Compositions

| | Sheet Stock Sample Number | | | | |
|---|---|---|---|---|---|
| | −60 | −61 | −62 | −63 | −64 |
| | Weight | Weight | Weight | Weight | Weight |
| Layer | % | % | % | % | % |
| Skim | | | | | |
| Polypropylene | 80.00 | 80.00 | 85.00 | 90.00 | 90.00 |
| random copolymer | | | | | |
| Polyolefin based | 20.00 | 20.00 | 15.00 | 10.00 | 10.00 |
| elastomer | | | | | |
| Cap | | | | | |
| High melt strength | 82.20 | 82.20 | 82.20 | 82.20 | 82.20 |
| polypropylene | | | | | |
| homopolymer | | | | | |
| 60% TiO₂ in resin | 0.80 | 0.80 | 0.80 | 0.80 | 0.80 |
| 60% talc in a | 15.00 | 15.00 | 15.00 | 15.00 | 15.00 |
| polypropylene | | | | | |
| homopolymer | | | | | |
| Nucleating Agent | 2.00 | 2.00 | 2.00 | 2.00 | 2.00 |
| Buffer | | | | | |
| High melt strength | 79.00 | 79.00 | 79.00 | 79.00 | 79.00 |
| polypropylene | | | | | |
| homopolymer | | | | | |
| 60% TiO₂ in resin | 4.00 | 4.00 | 4.00 | 4.00 | 4.00 |
| 60% talc in a | 15.00 | 15.00 | 15.00 | 15.00 | 15.00 |
| polypropylene | | | | | |
| homopolymer | | | | | |
| Nucleating Agent | 2.00 | 2.00 | 2.00 | 2.00 | 2.00 |
| Regrind | | | | | |
| Regrind | 89.10 | 93.10 | 89.00 | 89.00 | 93.10 |
| Polypropylene | 8.70 | 5.50 | 9.35 | 9.90 | 6.20 |
| random copolymer | | | | | |
| Polyolefin based | 2.20 | 1.40 | 1.65 | 1.10 | 0.70 |
| elastomer | | | | | |
| Tie | | | | | |
| Modified polyolefin | 75.00 | 75.00 | 75.00 | 75.00 | 75.00 |
| adhesive resin | | | | | |
| Polypropylene | 25.00 | 25.00 | 25.00 | 25.00 | 25.00 |
| random copolymer | | | | | |
| EVOH | | | | | |
| Ethylene vinyl | 100.00 | 100.00 | 100.00 | 100.00 | 100.00 |
| alcohol resin | | | | | |

Containers having the Stock design explained in Example 1 were formed from sheet stocks 60, 61, 62, 63, 64, and sheet stock “55” from Example 1 were tested for various punctureability characteristics using a commercially available traditional single-serve brewing machine puncture mechanism. The results of these tests are shown in FIGS. 15-17. None of the containers displayed any broken chads.

FIG. 15 is a graph showing the comparative results of the number of hanging chads formed in containers formed of materials 55, 60, 61, 62, 63, and 64. As can be seen, materials 63 and 55 displayed hanging chads while the other materials did not.

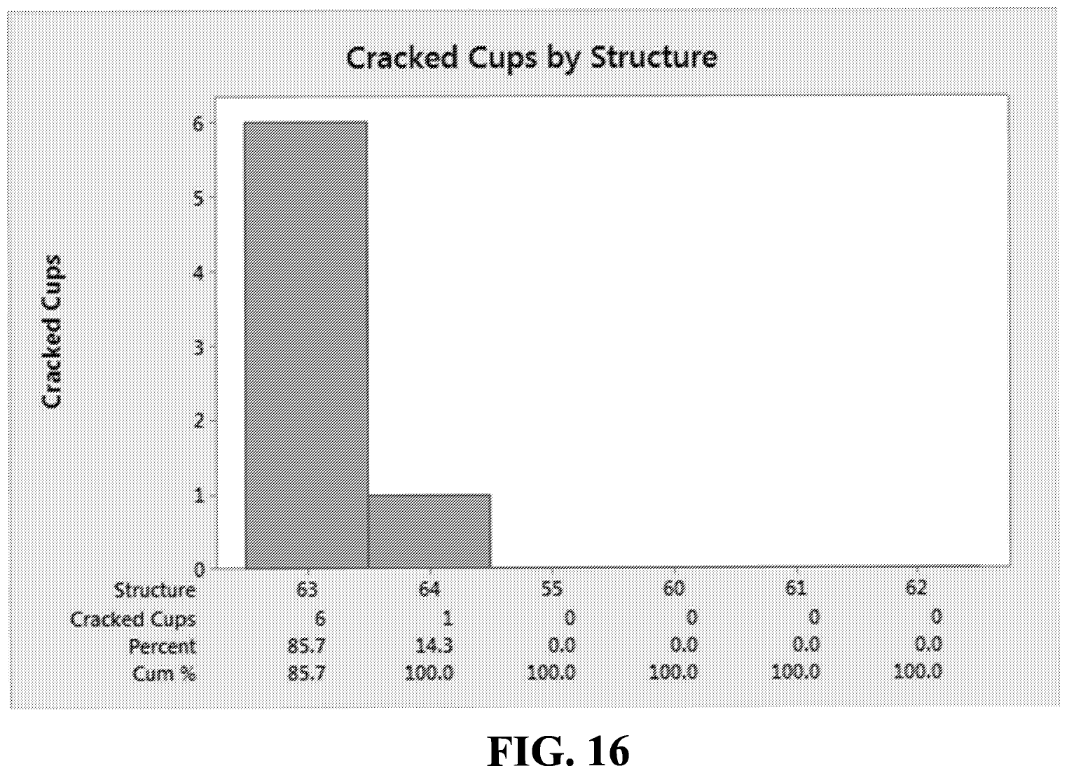

FIG. 16 is a graph showing the comparative results of the number of cracked cups resulting in containers formed of materials 55, 60, 61, 62, 63, and 64. As can be seen, materials 63 and 64 were the only containers that resulted in cracked containers, with 63 having significantly more cracked containers.

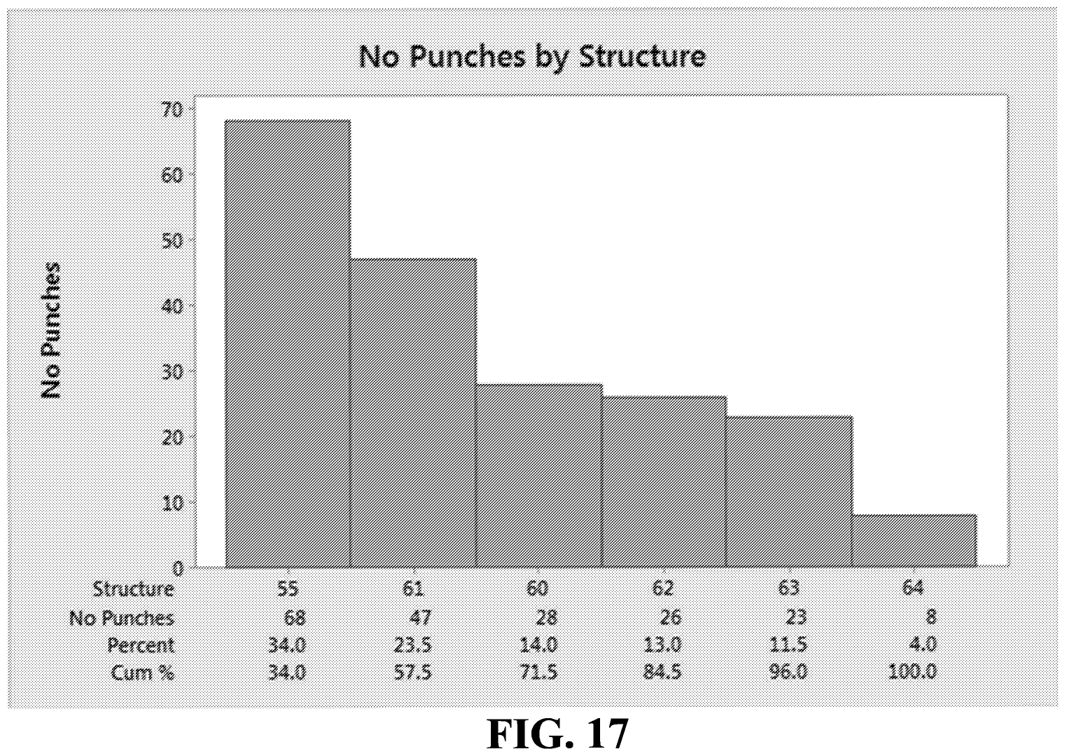

FIG. 17 is a graph showing the comparative results of the number of containers that did not puncture (punch) formed of material materials 55, 60, 61, 62, 63, and 64. As can be seen, each container displayed some percentage of no-punches, with materials 55 and 61 displaying the most.

Thus, the foregoing examples demonstrate that containers may be manufactured that are more easily recycled than traditional containers while providing the desired punctureability characteristics in automatic brewing machines, as well as reducing cracking and the formation of chads. Specifically, containers may be made predominantly of polypropylene and include a skim coat layer that is also made predominantly of a softer/lower melting point polypropylene. Such containers were shown in testing to significantly reduce the occurrence of detached and hanging chads as well as of cracked containers.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

1. A container, comprising:
a substantially circular base comprising a puncture region;
a frustoconically shaped wall extending from an edge of the base and defining a cavity therein;
wherein the container is formed of a first material layer comprising a monolayer of polypropylene homopolymer in an amount of at least 70 percent by weight, or a multilayer material in which at least one layer comprises a polypropylene homopolymer in an amount of at least 70 percent by weight of the at least one layer,
wherein the container is formed of a second material layer adjacent the first material layer and forming an innermost layer adjacent the cavity, the second material layer comprising a polypropylene copolymer in an amount of at least 60 percent by weight of the second material layer, and
wherein the second material layer has a thickness that is from about 0.5 percent to about 20 percent of a total thickness of the first material layer and the second material layer.

2. (canceled)

3. The container of claim 1, wherein the second material layer comprises the polypropylene copolymer in an amount of at least 75 percent by weight of the second material layer.

4. The container of claim 1, wherein the second material layer has a thickness that is from about 5 percent to about 15 percent of a total thickness of the first material layer and the second material layer.

5. (canceled)

6. The container of claim 1, wherein the base is punctureable by a single needle and displays a puncture load of less than 3 kg, measured using a sharp needle, or of less than 5 kg, measured using a dull needle.

7.-13. (canceled)

14. The container of claim 1, wherein the first material layer comprises the multilayer material and the multilayer material further comprises a barrier layer.

15. The container of claim 14, wherein the barrier layer comprises ethylene vinyl alcohol.

16. The container of claim 14, wherein the multilayer material further comprises at least one tie layer adjacent the barrier layer.

17. The container of claim 1, wherein the first material layer comprises the multilayer material and the multilayer material further comprises a second layer comprising the polypropylene homopolymer in an amount of at least 70 percent by weight of the second layer.

18. The container of claim 1, wherein:
the first material layer comprises the multilayer material and the multilayer material further comprises at least one buffer layer adjacent the at least one layer comprising the polypropylene homopolymer in an amount of at least 70 percent by weight of the at least one layer, and
the buffer layer comprises the polypropylene homopolymer in an amount from at least 70 up to 97 percent by weight of the layer, a nucleating agent in an amount from 0.5 to 5 percent by weight of the layer, and talc in an amount from 3 to 15 percent by weight of the layer.

19. The container of claim 1, wherein the first material layer comprises the multilayer material and the multilayer material further comprises at least one regrind layer.

20. The container of claim 19, wherein the at least one regrind layer comprises the polypropylene copolymer in an amount of at least 5 percent by weight of the layer.

21. The container of claim 1, wherein the first material layer is asymmetric.

22. The container of claim 1, wherein the second material layer is adjacent the monolayer of polypropylene homopolymer or the at least one layer comprising the polypropylene homopolymer of the multilayer material, with no tie layer being disposed therebetween.

23. A container for forming a beverage comprising the container of claim 1, and further comprising:
a filter disposed in the cavity of the container and defining first and second chambers in the cavity;
a beverage medium disposed in the cavity and arranged to interact with a liquid introduced into the container to form a beverage; and
a lid attached to a rim of the container to contain the beverage medium and filter disposed therein.

24. A sheet stock material for a container, comprising:
a first material layer comprising a monolayer of polypropylene homopolymer in an amount of at least 70 percent by weight, or a multilayer material in which at least one layer comprises a polypropylene homopolymer in an amount of at least 70 percent by weight of the at least one layer; and
a second material layer adjacent the first material layer, the second material layer comprising a polypropylene copolymer in an amount of at least 60 percent by weight of the second material layer,
wherein the second material layer has a thickness that is from about 0.5 percent to about 20 percent of a total thickness of the first material layer and the second material layer, and
wherein the container comprises a substantially circular base and a frustoconical shaped wall extending from an edge of the base and defining a cavity therein.

25. (canceled)

26. The sheet stock material of claim 24, wherein the second material layer comprises the polypropylene copolymer in an amount of at least 75 percent by weight of the second material layer.

27. The sheet stock material of claim 24, wherein the second material layer has a thickness that is from about 5 percent to about 15 percent of a total thickness of the first material layer and the second material layer.

28.-30. (canceled)

31. The sheet stock material of claim 24, wherein the first material layer comprises the multilayer material and the multilayer material further comprises a barrier layer.

32. The sheet stock material of claim 31, wherein the barrier layer comprises ethylene vinyl alcohol.

33. The sheet stock material of claim 31, wherein the multilayer material further comprises at least one tie layer adjacent the barrier layer.

34. The sheet stock material of claim 24, wherein the first material layer comprises the multilayer material and the multilayer material further comprises a second layer comprising the polypropylene homopolymer in an amount of at least 70 percent by weight of the second layer.

35. The sheet stock material of claim 24, wherein:
the first material layer comprises the multilayer material and the multilayer material further comprises at least one buffer layer adjacent the at least one layer comprising the polypropylene homopolymer in an amount of at least 70 percent by weight of the at least one layer, and
the buffer layer comprises the polypropylene homopolymer in an amount from at least 70 up to 97 percent by weight of the layer, a nucleating agent in an amount from 0.5 to 5 percent by weight of the layer, and talc in an amount from 3 to 15 percent by weight of the layer.

36. The sheet stock material of claim 24, wherein the first material layer comprises the multilayer material and the multilayer material further comprises at least one regrind layer.

37. The sheet stock material of claim 36, wherein the at least one regrind layer comprises the polypropylene copolymer in an amount of at least 5 percent by weight of the layer.

38. The sheet stock material of claim 24, wherein the first material layer is asymmetric.

39. The sheet stock material of claim 24, wherein the second material layer is adjacent the monolayer of polypropylene homopolymer or the at least one layer comprising the polypropylene homopolymer of the multilayer material, with no tie layer being disposed therebetween.

40. A method of making a container, comprising:
providing the sheet stock material of claim 24;
heating the sheet stock material; and
drawing the heated sheet stock material into a mold to form a container.

41.-48. (canceled)

49. The container of claim 1, wherein the second material layer comprises a material that is softer than the first material layer, has a lower melting point than the first material layer, or both.

50. The sheet stock of claim 26, wherein the second material layer comprises a material that is softer than the first material layer, has a lower melting point than the first material layer, or both.

51. (canceled)
